(19) United States
(12) Patent Application Publication
(10) Pub. No.: US 2004/0202743 A1
(43) Pub. Date: Oct. 14, 2004

(54) Process and apparatus for injection moulding

(76) Inventor: Terence Colwyn Pearson, Nantwich (GB)

Correspondence Address: John A Artz, Artz & Artz, Suite 250, 28333 Telegraph Road, Southfield, MI, 48034, US

(21) Appl. No.: 10/483,356

(22) PCT Filed: Jul. 10, 2002
(86) PCT No.: PCT/GB02/03200

(30) Foreign Application Priority Data
Jul. 10, 2001 (US) 09/902,354
Jul. 30, 2001 (US) 09/918,234
Sep. 14, 2001 (GB) 0122292.6

(51) Int. Cl. B29C 45/16; B29C 45/20

(52) U.S. Cl. 425/130; 425/149; 425/564; 425/572; 425/568; 425/585

(57) ABSTRACT

A process and apparatus for plastics injection moulding comprises injecting a quantity of molten plastics material into a mould cavity (30) and injecting pressurised gas (52) or pressurised liquid into the plastics material in the mould cavity. After holding the pressure of the gas or liquid on the plastics material in the mould cavity for a period of time in order to apply a packing pressure to the plastics material, a portion of the molten plastics material is expelled into one or more secondary cavities (32) or expelled back into the barrel (22) of the injection moulding machine. The step of injecting the plastics material may be effected with or without packing of the plastics material prior to the injection of the pressurised gas or liquid.

The present invention relates to a process and apparatus for injection moulding hollow plastics articles.

Injection moulding of plastics materials is well known and widely practised as a means of manufacturing an ever-increasing diversity of plastics components for industrial and consumer use. During the last two decades, versions of the process globally referred to as “gas assisted moulding” have been developed and used to overcome some of the problems inherent in conventional injection moulding, and to reduce costs, and improve the quality of the final products.

In conventional gas assisted injection moulding, a gas, such as nitrogen, is injected into the molten plastics material after it has entered the mould cavity. The low viscosity gas flows into the paths of least resistance within the more viscous plastics, thereby forming hollow channels within the plastics. The process is particularly beneficial for thick section mouldings, such as handles, and weight savings of up to 45% or more can result. Also, the moulding time cycles can be substantially reduced. In multi-section mouldings, the injected gas tends to flow into the thicker sections, again forming hollow continuous channels through which pressure may be transmitted through the medium of the gas. This adds to the scope of the designer and removes some of the design restrictions of conventional moulding.

One conventional gas assisted plastics moulding process partially fills the mould cavity with an accurately controlled shot volume of plastics. Gas is then injected in order to continue the flow of plastics so that the cavity is filled with plastics and gas. The gas is used to exert outward pressure on the plastics material forcing it against the mould cavity surfaces, thereby achieving a good replication of the mould surface on the plastics moulded surface. After the plastics has solidified, the gas pressure is reduced by exhausting the gas to atmosphere, and the mould is opened and the part ejected. This is sometimes referred to as a “short shot” process.

In another method, the mould cavity is completely or substantially filled with plastics material and then instead of injecting or packing more plastics into the cavity to compensate for the volumetric shrinkage of the plastics as it cools and solidifies, gas is injected into the plastics so that the gas expansion compensates for the plastics contraction. In practice, the initial gas penetration will continue to expand during the cooling cycle while the plastics is shrinking in volume. This is sometimes referred to as a “full shot” process.

In the “full shot” process, it is sometimes difficult to achieve sufficient gas penetration along intended gas channels because there is insufficient volumetric shrinkage of the plastics to provide space for the gas. In such cases, a method of enabling some plastics to outflow from the mould cavity into overflow wells or “secondary” cavities is helpful in providing space for the gas expansion.

In the “short shot” method, some mouldings may also be difficult to fill with plastics and gas to the extremities of the mould cavity. If the shot volume is too little, the gas may break through the leading edge of the plastics material during filling, thereby losing control of the gas. If the shot volume is too high, the gas will not reach the extremities of the mould cavity. Therefore thick section mouldings using the “short shot” process can also benefit from an additional displacement of plastics from the mould cavity into an overflow cavity.

A method of at least partially filling the mould cavity before injection of the gas and employing an overflow cavity is described in U.S. Pat. No. 5,098,637. However, in order to use the method of this patent successfully, it is necessary to accurately control the shot volume for both “short shot” and “full shot” methods, because there is no resistance to prevent the plastics from flowing into and filling the overflow cavity before the gas is injected.

In the “short shot” process, the flow of plastics is temporarily stopped at the end of the filling sequence, and then typically there is a delay of up to five seconds before injection of the gas urges the plastics forward to complete the filling of the article cavity with plastics and gas and the overflow cavity with plastics. In the “full shot” process, the mould cavity is filled with, or substantially filled with, molten plastics and the gas is injected to compensate for the volumetric shrinkage of the plastics and to displace plastics into the overflow cavity. In both cases, since the runner to the overflow cavity is open, it is not feasible to apply “packing pressure” to the plastics in the mould cavity before displacement of the plastics into the overflow cavity occurs i.e. there is nothing to restrain the further flow of plastics. Furthermore, in the “short shot” process, or when nearly filling the cavity in a “full shot” process, there may remain unsightly visible hesitation lines or marks on the moulding surface at the position of the first plastics injection.

Another method is disclosed in Japanese Patent Application No. 50-74660, in which a shut-off valve is positioned in a runner connecting the mould cavity and a “secondary cavity”. In this application, the mould cavity is filled with thermoplastics resin and then a core resin or gas is injected-into the mould cavity while, thermoplastics resin is expelled from the mould cavity.

According to one aspect of the invention there is provided a process for injection moulding a hollow plastics article comprising the steps of injecting a quantity of molten plastics material into a mould cavity at least to substantially fill the mould cavity; injecting pressurised gas or pressurised liquid into the plastics material in the mould cavity; allowing a portion of the molten plastics material in the mould to be expelled into at least one secondary cavity coupled to the mould cavity permitting the remaining plastics material in the mould cavity to solidify; exhausting the gas or liquid from the mould cavity; and removing the plastics article from the mould; characterised by holding the pressure of the gas or liquid on the plastics material in the mould cavity for a period of time in order to apply a packing pressure to the plastics material before allowing a portion of the plastics material to be expelled into said at least one secondary cavity.

Preferably the step of holding the pressure of the gas or liquid on the plastics material in the mould cavity ensures that the plastics material is held against a wall surface of the mould cavity and an outer skin of the plastics material has solidified whilst a core portion of the plastics material remains molten.

In one embodiment the step of injecting plastics material into the mould cavity is effected without packing of the plastics material.

In another embodiment the process includes the step of applying a packing pressure to the plastics material injection pressure in the mould cavity, prior to the injection of the pressurised gas or liquid into the plastics material in the mould cavity. Preferably an injection moulding machine is employed to inject the plastics material into the mould cavity and to apply an initial packing pressure to the plastics material, the pressurised gas or liquid applying a further packing pressure to the plastics material in the mould cavity.

Preferably the process comprises the step of applying the packing pressure to the plastics material injection pressure in the mould cavity for a predetermined amount of time prior to the injection of gas or liquid into the plastics material.

Preferably the expulsion step is achieved by opening a valve in a flow runner or conduit connecting the mould cavity to the or each secondary cavity whilst maintaining gas or liquid pressure in the mould cavity.

In one embodiment the plastics article to be moulded has at least one section which is thicker than other sections and the charge of pressurised gas or liquid is introduced into the thicker section in order to form a hollow portion therein.

The process may include the step of adjusting the volume of the at least one secondary cavity in order to allow expulsion of a predetermined amount of plastics material from the mould cavity.

Portions of the plastics material may be expelled into at least two subsidiary cavities.

In one embodiment at least two secondary cavities are provided and the step of allowing portions of the plastics material in the mould to be expelled into the secondary cavities comprises opening valve members positioned in respective flow runners or conduits connecting the mould cavity with the secondary cavities. The process may further comprise the step of sequentially controlling the opening of the valve members in order to allow selective expelling of plastics material into the at least two secondary cavities.

In one embodiment the process is applied for injection moulding a hollow plastics tubular article, the mould cavity having a substantially cone-shaped inlet portion, an elongate central portion and an exit portion.

Preferably said cone-shaped portion has an apex and said gas or liquid is injected into the plastics material at said apex.

It is also preferred that said exit portion comprises a second substantially cone-shaped portion, said cone-shaped exit portion having an apex and said expulsion of plastics material from the mould cavity into the secondary cavity occurs through said apex.

Preferably the plastics material is injected into the mould cavity at said cone-shaped inlet portion and maintains contact with the surfaces of the mould cavity as the mould cavity is filled.

There may be provided a ring gate mechanism for injecting the plastics material into said cone-shaped inlet portion.

The process preferably includes the step of trimming at least one end of the article to form a tubular article. Thereby the article may be trimmed to form a tubular article of substantially constant cross-section.

The plastics material may be injected into the mould cavity from an injection moulding machine with a barrel and nozzle, and the process includes the step of allowing a portion of the plastics material in the mould to be expelled back into the barrel of the injection moulding machine, the barrel constituting the secondary cavity or one of the secondary cavities.

According to another aspect of the invention there is provided a process for injection moulding a hollow plastics article utilising an injection moulding machine with a barrel and nozzle and a mould with a mould cavity therein having a shape defining at least a portion of the article, said process comprising the steps of injecting a quantity of molten plastics material into the mould cavity from the injection moulding machine at least to substantially fill the mould cavity; injecting pressurised gas or pressurised liquid into the plastics material in the mould cavity; allowing a portion of the molten plastics material in the mould to be expelled back into the barrel of the injection moulding machine; permitting the remaining plastics material in the mould cavity to solidify; exhausting the gas or liquid from the mould cavity; and removing the plastics article from the mould; characterised by holding the pressure of the gas or liquid on the plastics material in the mould cavity for a period of time in order to apply a packing pressure to the plastics material before allowing said portion of the plastics material in the mould to be expelled back into the barrel of the injection moulding machine.

Preferably the step of holding the pressure of the gas or liquid on the plastics material in the mould cavity ensures that the plastics material is held against a wall surface of the mould cavity and an outer skin of the plastics material has solidified whilst a core portion of the plastics material remains molten.

In one embodiment the step of injecting plastics material into the mould cavity is effected without packing the plastics material.

In another embodiment the injection moulding machine is employed to apply a packing pressure to the plastics material injection pressure in the mould cavity, prior to the injection of pressurised gas or liquid into the plastics material.

Preferably the step of allowing plastics material to be expelled back into the barrel of the injection moulding machine is controlled so that a predetermined amount is expelled in a controlled manner.

In one embodiment, the amount of plastics material which is expelled is controlled by controlling the speed and/or the extent by which the plastics material retracts an injection piston or screw in the barrel of the injection moulding machine.

Additionally or alternatively the amount of plastics material which is expelled is controlled by timing the closure of a shut-off valve member positioned in the flow path between the mould cavity and the barrel of the injection moulding machine.

It is also preferred that the gas or liquid is injected into the plastics material at a location spaced from the nozzle of the injection moulding machine.

Preferably the step of allowing a portion of the plastics material in the mould to be expelled back into the barrel of the injection moulding machine comprises opening a shut-off valve member positioned in the flow path between the mould cavity and the barrel of the injection moulding machine. The valve member is preferably included as part of the nozzle of the injection moulding machine.

In one embodiment a first portion of plastics material in the mould is allowed to be expelled back into the barrel of the injection moulding machine, and the process comprises the step of also allowing a respective second portion of the plastics material in the mould to be expelled into one or more secondary cavities coupled to the mould cavity.

Preferably the step of allowing one or more second portions of the plastics material to be expelled into a respective secondary cavity comprises opening a valve member positioned in the flow path between the mould cavity and the secondary cavity.

The invention also provides apparatus for, injection moulding a hollow plastics article comprising a mould with a mould cavity therein defining at least a portion of the article and at least one secondary cavity coupled to the mould cavity; means for injecting a quantity of molten plastics material into the mould cavity at least to substantially fill the mould cavity; and means for injecting pressurised gas or pressurised liquid into the plastics material in the mould cavity in order to apply a packing pressure to the plastics material; characterised in that control means are provided for holding the pressure of the gas or liquid on the plastics material in the mould cavity for a period of time in order to apply a packing pressure to the plastics material before allowing a portion of the molten plastics material in the mould to be expelled into said at least one secondary cavity, prior to the remaining plastics material in the mould cavity solidifying and the gas or liquid being exhausted from the mould cavity to allow the removal of the plastics article from the mould cavity.

In one embodiment an injection moulding machine is employed to inject the plastics material into the mould cavity without packing the plastics material.

In another embodiment an injection moulding machine is employed to inject the plastics material into the mould cavity, and to apply a packing pressure to the plastics material injection pressure in the mould cavity, prior to the injection of the pressurised gas or liquid into the plastics material in the mould cavity.

Preferably the or each secondary cavity is connected to the mould cavity by a flow runner or conduit containing a valve controlled by said control means.

In one embodiment the mould cavity is coupled to at least two secondary cavities by a respective flow runner or conduit, each coupling containing a controlled valve.

Preferably the means for injecting plastics material into'the mould cavity is an injection moulding machine with a barrel and nozzle, the nozzle being flow connected to the mould cavity and the barrel constituting a further secondary cavity.

Preferably a shut-off valve member is positioned in the flow path between the mould cavity and the barrel of the injection moulding machine. The valve member may be included as part of the nozzle of the injection moulding machine.

For injection moulding a hollow plastics tubular article, the mould cavity preferably has a substantially cone-shaped inlet portion, an elongate central portion and an exit portion. Preferably the cone-shaped portion has an apex and the fluid is injected into the plastics material at the apex. The exit portion may comprise a second substantially cone-shaped portion, said cone-shaped exit portion having an apex and said expulsion of plastics material from the mould cavity into the secondary cavity occurs through said apex. There may be provided a ring gate mechanism for injecting the plastics material into said cone-shaped inlet portion.

Means may be provided for trimming at least an end of the article to form a tubular article.

The invention still further provides apparatus for injection moulding a hollow plastics article comprising an injection moulding machine with a barrel and a nozzle; a mould with a mould cavity therein defining at least a portion of the article, for, connection to the nozzle for injecting a quantity of molten plastics material into the mould cavity from the injection moulding machine; and means for injecting pressurised gas or pressurised liquid into the plastics material in the mould cavity in order to apply a packing pressure to the plastics material; characterised in that control means are provided for holding the pressure of the gas or liquid on the plastics material in the mould cavity for a period of time in order to apply a packing pressure to the plastics material before allowing a portion of the molten plastics material in the mould to be expelled back into the barrel of the injection moulding machine, prior to the remaining plastics material in the mould cavity solidifying and the gas or liquid being exhausted from the mould cavity to allow the removal of the plastics article from the mould.

In one embodiment the injection moulding machine is employed to inject the plastics material into the mould cavity without packing the plastics material.

In another embodiment the injection moulding machine applies a packing pressure to the plastics material injection pressure in the mould cavity, prior to the injection of the pressurised gas or liquid into the plastics material in the mould cavity.

By way of example, specific embodiments in accordance with the invention will be described with reference to the accompanying schematic drawings in which:—

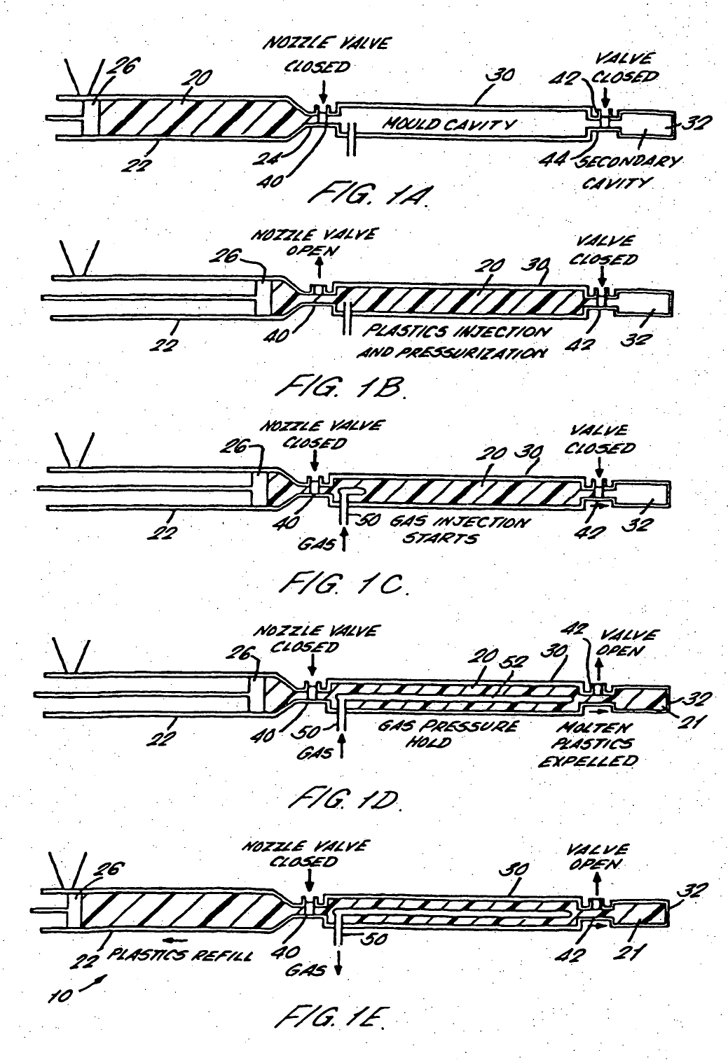

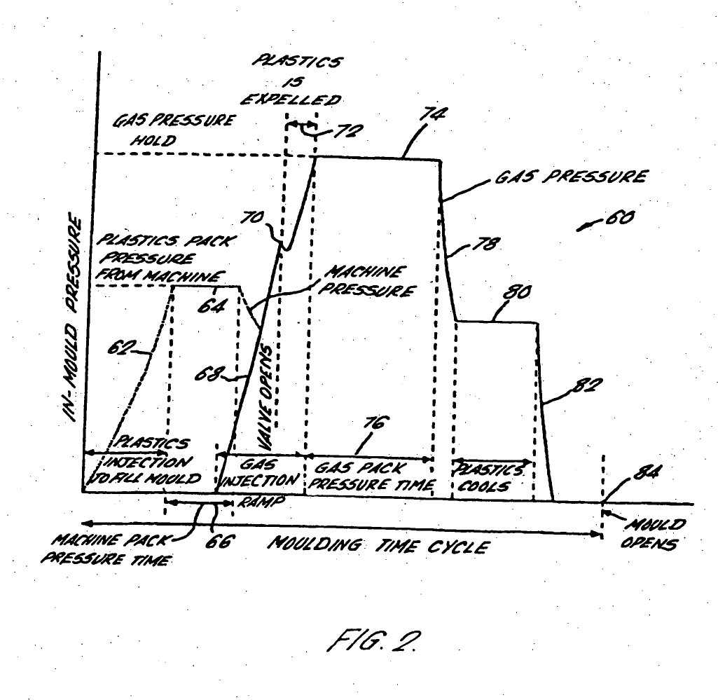

FIGS. 1A-1E illustrate a sequence of steps in a first embodiment;

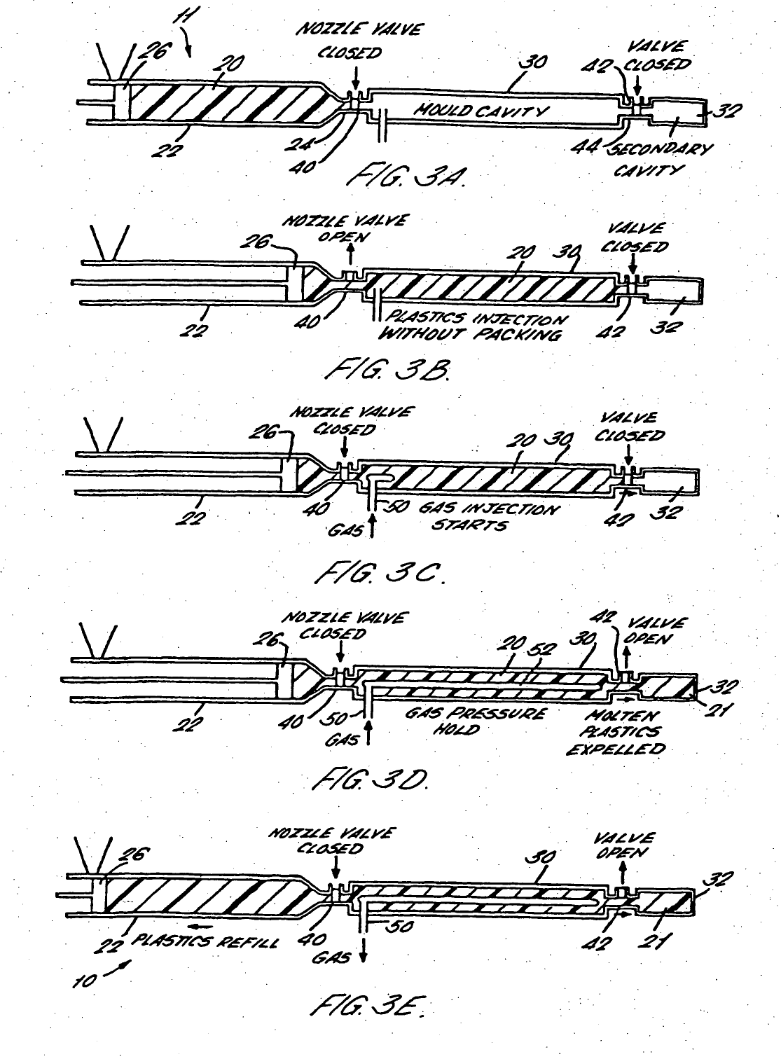

FIG. 2 is a graph further illustrating the in mould pressure time sequence as set forth in FIGS. 1A-1E;

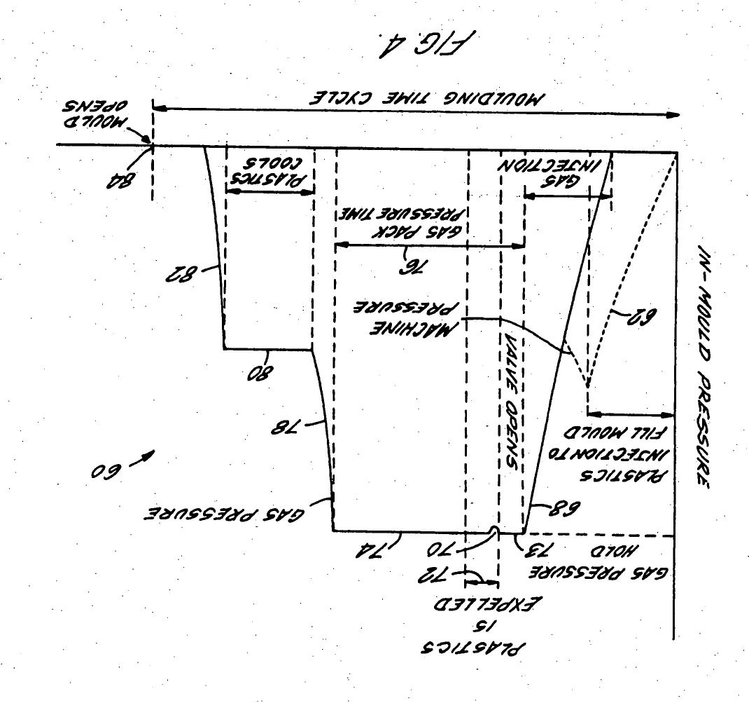

FIGS. 3A-3E illustrate an alternative sequence of steps to the embodiment of FIGS. 1A-1E.

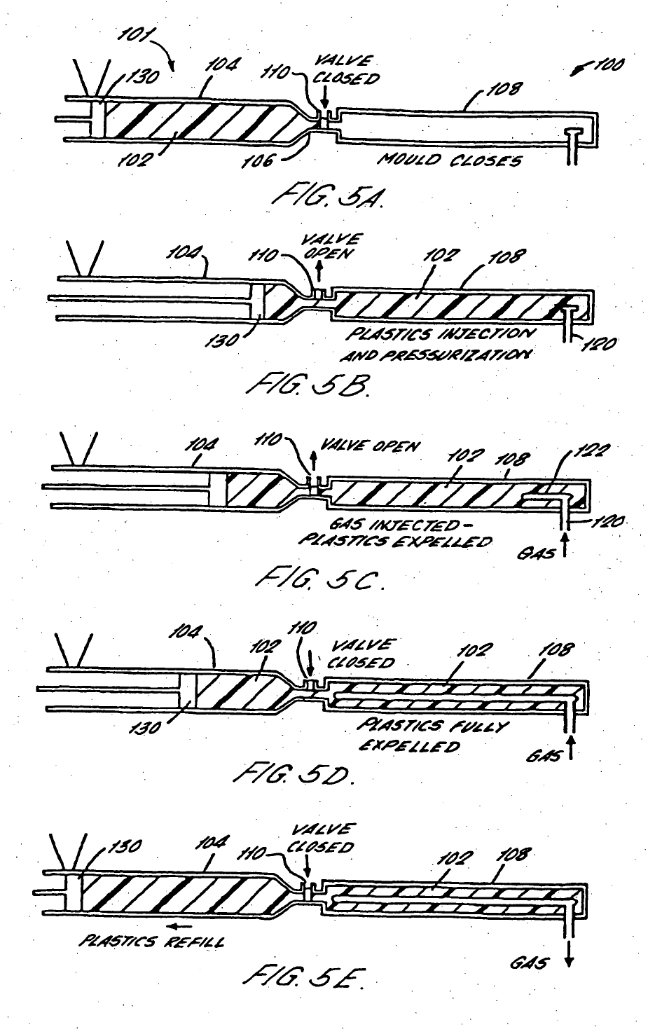

FIG. 4 is a graph further illustrating the in mould pressure time sequence as set forth in FIGS. 3A-3E;

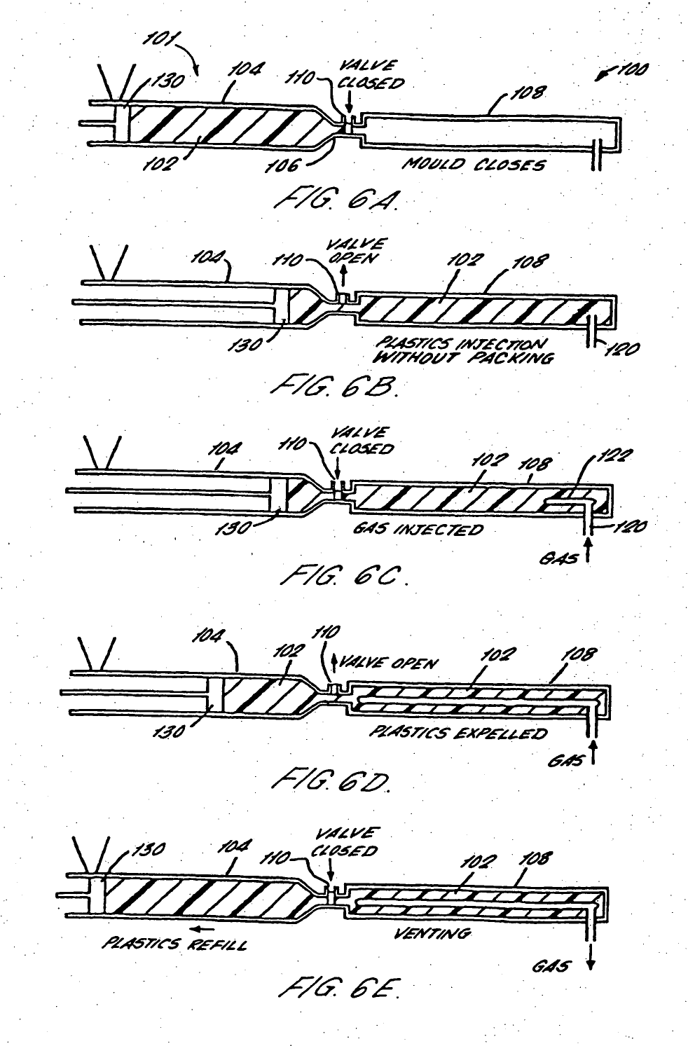

FIGS. 5A-5E illustrate a sequence of steps in another embodiment;

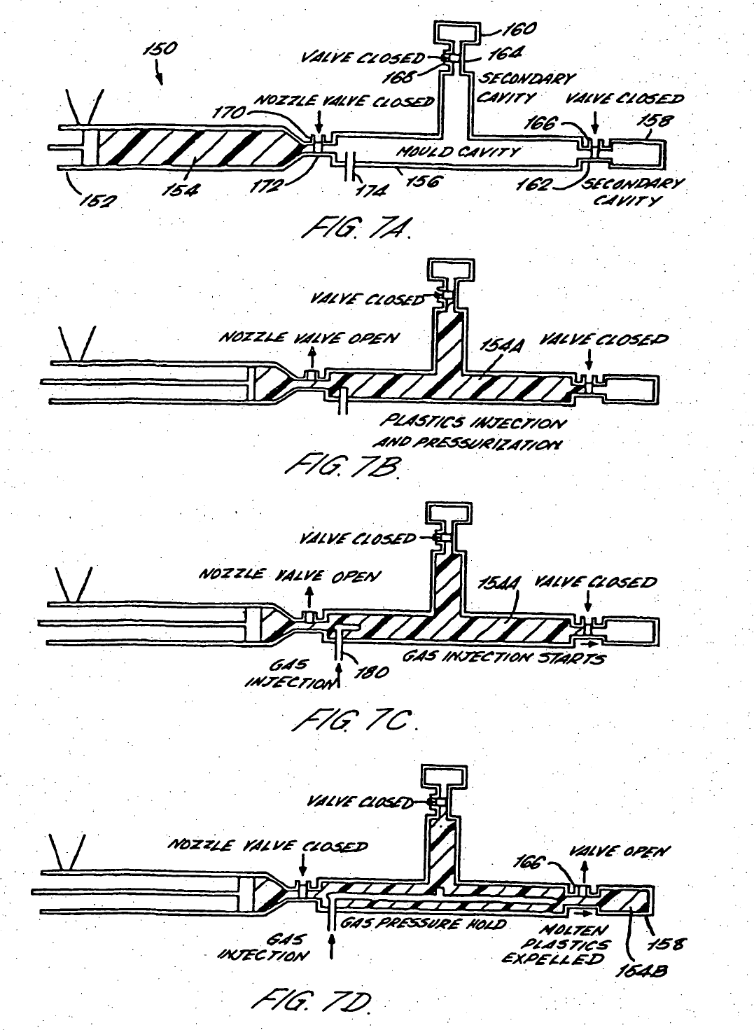

FIGS. 6A-6E illustrate an alternative sequence of steps to the embodiment of FIGS. 5A-5E;

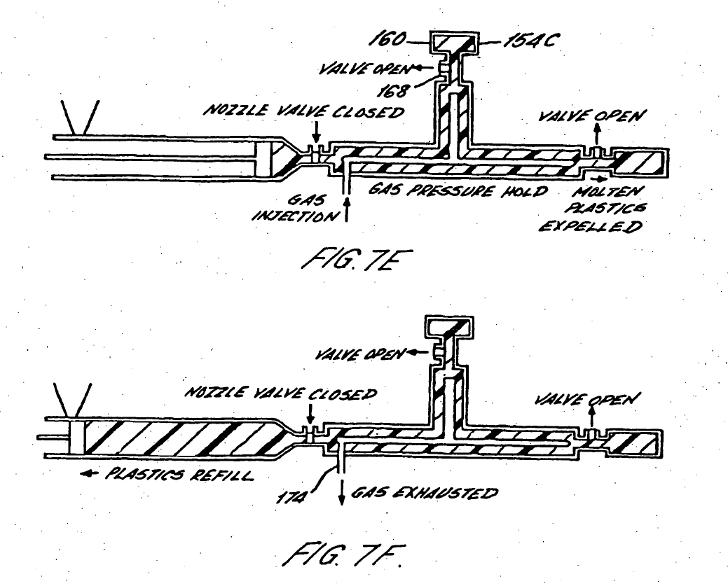

FIGS. 7A-7F illustrate a further embodiment of the invention in which two secondary cavities are utilised;

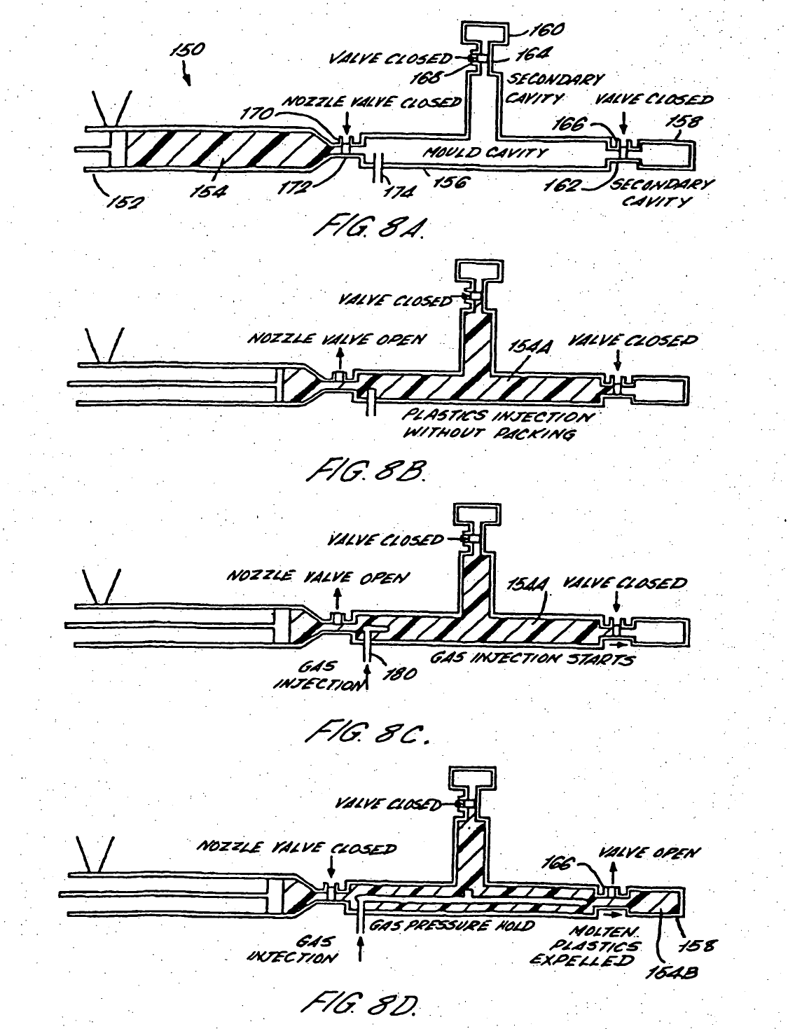

FIGS. 8A-8F illustrate an alternative sequence of steps to the embodiment of FIGS. 7A-7F;

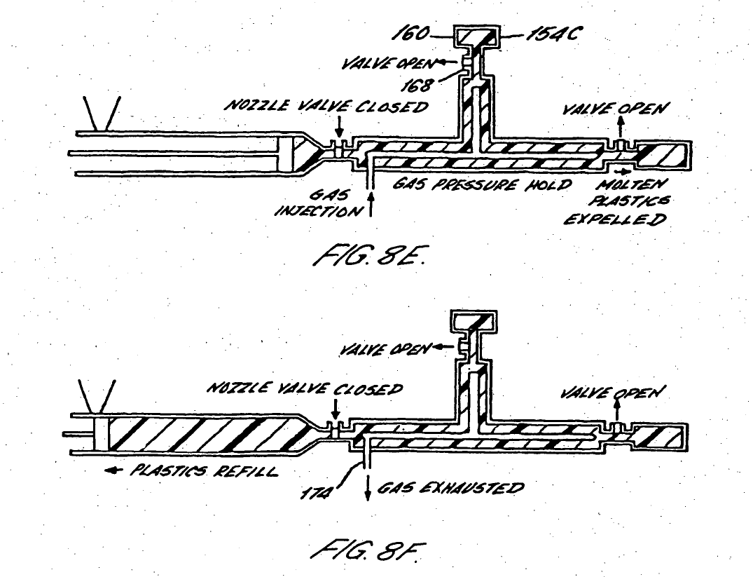

FIGS. 9A-9F illustrate a sequence of steps in a still further embodiment, particularly used for the manufacture of hollow tubular components;

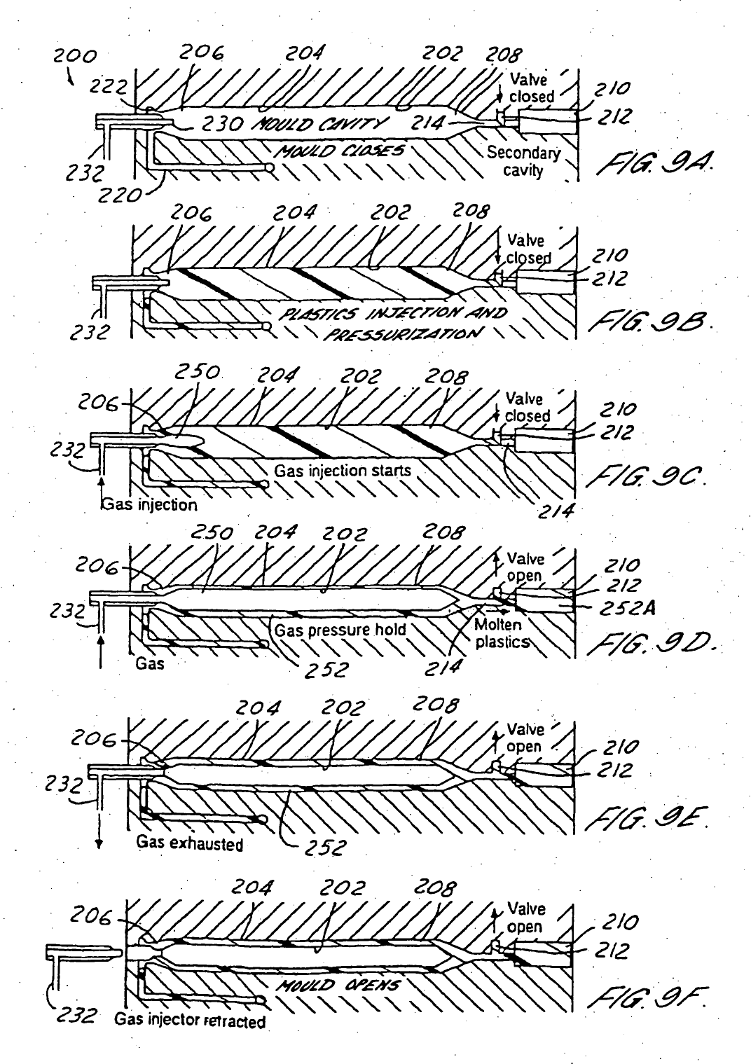

FIGS. 10A-10F illustrate an alternative sequence of steps to the embodiment of FIGS. 9A-9E;

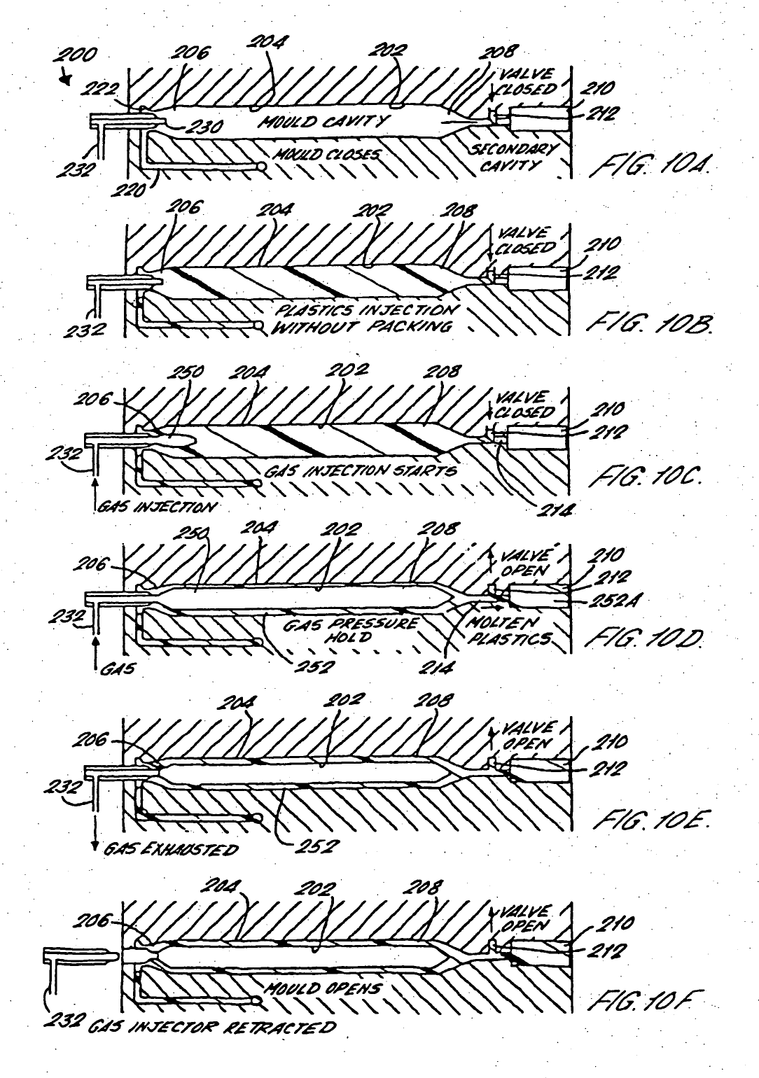

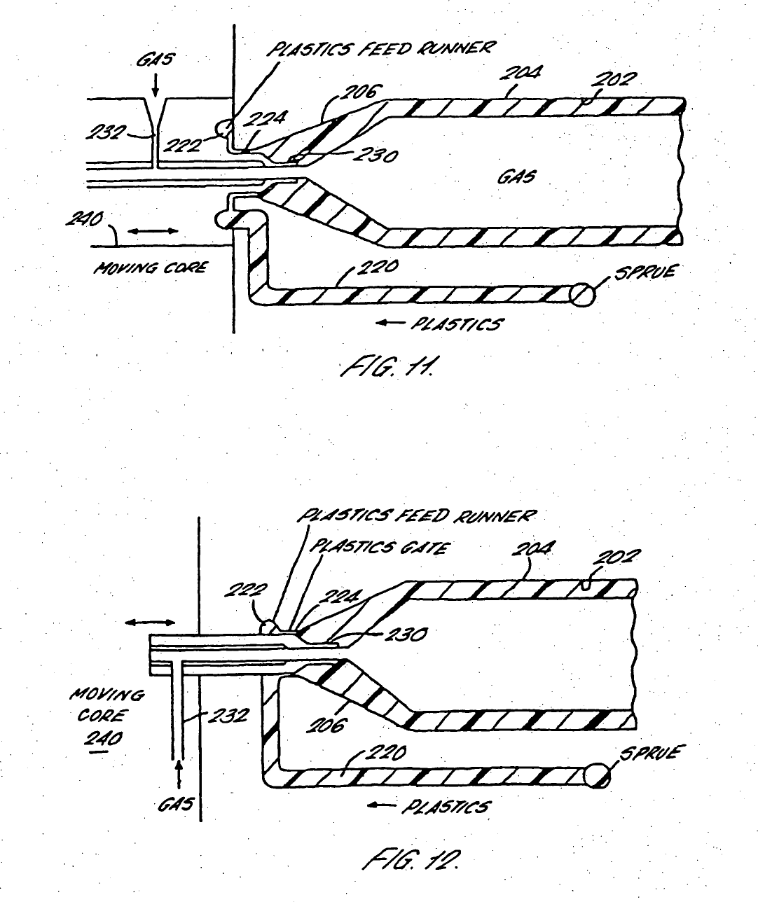

FIGS. 11 and 12 illustrate alternative embodiments at the entrance end of the hollow tubular component embodiment; and

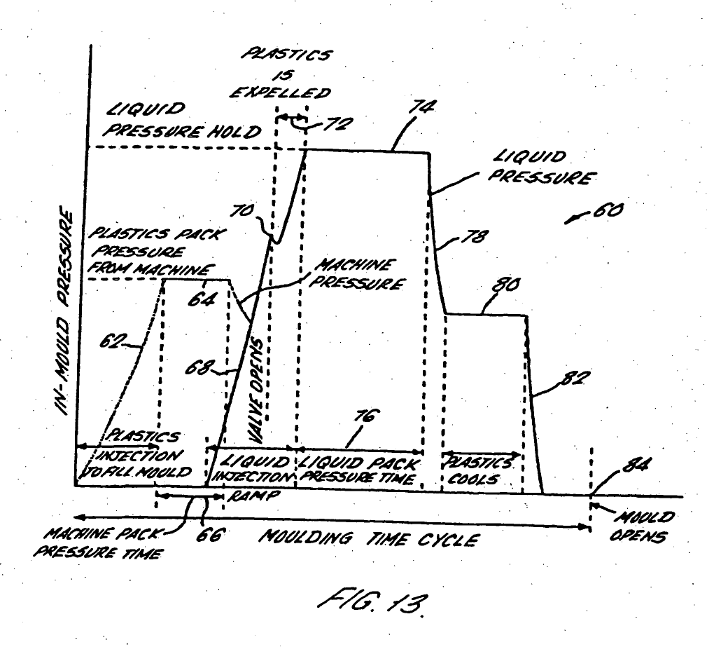

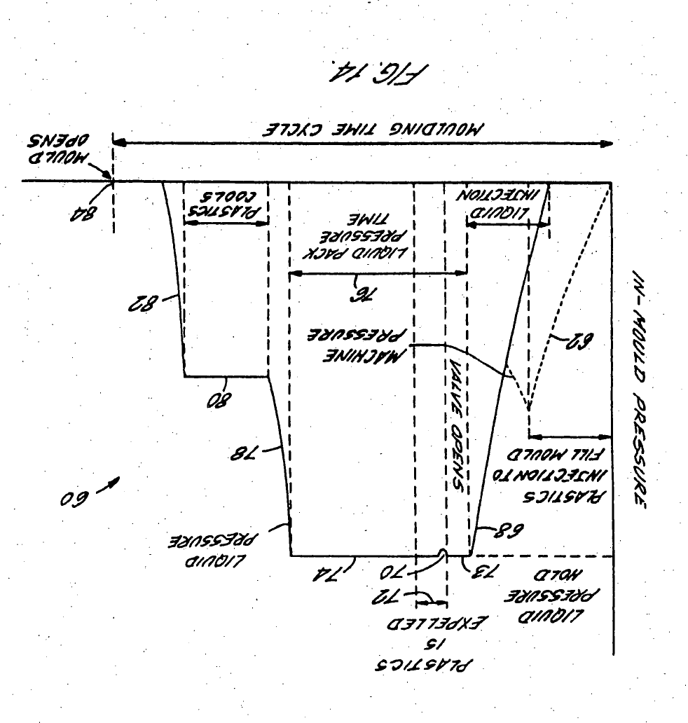

FIGS. 13 and 14 are graphs illustrating alternative in mould pressure time sequences when employing liquid as the pressurised fluid.

FIGS. 1A-1E illustrate the sequence steps of an embodiment of the present invention. This process is referred to generally by the reference numeral 10 in the drawings. In FIG. 1A, a quantity of molten plastics material 20 is positioned in the barrel 22 of an injection moulding machine. The injection moulding machine can be of any conventional type and can expel the plastics material from the nozzle 24 of the barrel in any conventional manner, such as by a helical screw or a piston 26. Although a piston member 26 is shown and illustrated and described in FIGS. 1A-1E, it is to be understood that any conventional mechanism used to expel the plastics material from a barrel of an injection moulding machine can be utilised.

As shown in FIG. 1A, the nozzle 24 of the injection moulding machine is connected to a mould cavity 30. The mould cavity 30 is positioned in a conventional mould which in turn is positioned in a conventional moulding machine. In this embodiment, the mould cavity 30 represents a thicker section of the article to be moulded. A secondary cavity 32 is positioned within the mould in communication with the mould cavity 30, and coupled to the mould cavity by a flow runner or conduit 44. A valve member 40 is positioned between the nozzle 24 and the mould cavity 30 while a second valve member 42 is positioned in the flow runner or conduit 44. The valve members 40 and 42 can be of any conventional type, but in this embodiment are shut-off type valve members, and can be operated in any conventional manner, such as pneumatically, hydraulically, electrically, etc. Control of the valve members 40 and 42 can also be accomplished with any conventional mechanism or system. For example, the mechanism can be computer operated so that the valves can be accurately timed to open and close as desired in accordance with a prespecified injection moulding process.

The quantity of plastics material 20 in the barrel 22 of the injection moulding machine is sufficient to fill or substantially fill the volume of the mould cavity 30. The plastics material 20 which can be used or utilised with the present invention can be of any conventional type, such as a thermoplastics resin. The plastics material can also be a filled material, that is mixed with a glass or mineral material.

In an alternative embodiment, two or more secondary cavities can be provided. The secondary cavities are each connected to the mould cavity 30 by separate runners or conduits 44. Also, independently controlled separate valve members are positioned in each of the runners or conduits 44 between the mould cavity 30 and the secondary cavities. In this embodiment, the secondary cavities constitute overflow cavities, which can be filled separately and the valve members 42 are timed in order to allow the plastics material to'be expelled as desired and where necessary in order to optimise the production process and plastics product produced by the process.

Referring back to FIG. 1, the second step in the process is shown in FIG. 1B. In this step, the plastics resin material 20 is injected by the molten injection moulding machine into the mould cavity 30. For this process step, valve member 40 is opened in order to allow plastics material to enter the mould cavity 30, but valve member 42 is retained in a closed position in order to prevent any plastics from entering the secondary cavity 32. The plastics in the mould cavity is then pressurised by the moulding machine (“packing pressure”) for a short predetermined period of time, for example 1-5 seconds. This assists to ensure good reproducibility of the mould surface on the moulded article in the cavity.

At this point, the gas is injected at selected ram and hold pressures. As explained above, this is possible in the case of a full shot process due to the volumetric contraction or shrinkage of the plastics material in the mould cavity 30. In the schematic embodiment shown, gas, for example nitrogen, is injected through inlet conduit 50. This is shown in FIG. 1C. Initially, the valve member 42 remains in a closed condition for a predetermined amount of time such that the pressure of the gas creates a hollow cavity in the molten material 20 and forces the plastics material against the inner wall surfaces of the mould cavity, and an outer skin of the plastics material has solidified whilst a core portion of the plastics material remains molten, thereby helping to provide a good surface finish on the plastics product.

Thereafter, as shown in FIG. 1D, the valve member 40 is closed and the valve member 42 opened. The pressure of the gas 52 in the molten plastics material 20 in the mould cavity 30 causes a portion of the molten plastics to be expelled from the mould cavity into the secondary cavity 32. In this regard, the molten plastics material is preferably expelled from the centre of the thicker sections in the mould article through the connecting gates or runner 44. Thereafter, a gas “hold” or “packing” pressure is maintained in the mould cavity whilst the remaining plastics material cools and solidifies. This takes in the order of 10-25 seconds or longer, depending on the size and thickness of the moulded plastics product.

It is generally necessary to adjust the volume of the or each secondary cavity 32 after the first or subsequent mould test trial in order to match the volume of the respective secondary cavity with the volume of plastics required to be expelled from the moulding cavity. This may be done by metal machining or removal from the mould to increase the volume., or addition of metal to reduce the volume. Initially, the volume of plastics expelled into the or each secondary cavity is determined by the time at, which the valve member 42 is opened. If the valve opening time is prolonged, more of the plastics solidifies in the mould cavity, i.e. the solid skin of plastics will thicken, and less is expelled; conversely, if the valve opening time is advanced, i.e. the delay time in opening is reduced, the skin thickness is reduced and more plastics is expelled. When the balance of secondary cavity volume and valve opening time is optimised, the process can be operated consistently shot-after-shot in production.

The amount of plastics material which is expelled into the overflow cavity can also be controlled by the time at which the valve member 42 is opened.

It is also possible to operate the present process with valve member 40 open or without use of a valve such as valve member 40 positioned between the injection moulding machine and the mould, by holding piston 26 in its forward position. However, it is preferable to close valve member 40 or an equivalent hot runner valve gate, to provide positive means for preventing plastics from being forced back into the screw or piston cylinder, i.e. the barrel 22, when pressurised by the gas.

Once the remaining plastics material in the mould cavity has sufficiently cooled and solidified, the gas 52 is exhausted, for example., back through conduit 50. This is shown in FIG. 1E. The expelled gas can be either collected and reclaimed for further use, or expelled into the atmosphere. Mechanisms and systems for exhausting or venting pressurised gas from the interior of the moulded article preparatory to opening the mould are described in numerous patents in the prior art. In this regard, any conventional mechanism or system for exhausting or venting the gas from the mould and moulded article can be utilised in accordance with the present invention. At the same time that the gas is exhausted, the piston or ram 26 of the injection moulding machine is typically retracted to its rest position (as illustrated) in preparation for another shot of plastics material.

Once the gas is vented or exhausted from the mould cavity, the mould is opened and the finished plastics product is ejected or removed from the mould cavity. At the same time, the expelled plastics material 21; in the secondary cavity 32 is similarly ejected or removed from the mould. The plastics in the secondary cavity 32 can be reground and reused, if desired, to avoid waste of material, or the cavity itself can be used to form another plastics part for possible use.

The positioning of one or more injectors 50 in the mould cavity should preferably be adjacent to the thicker sections and remote from, and at the opposite extremity to, the expulsion gates and runners. In the case of two or more gas injectors in the mould cavity, the commencement of gas injection from each gas feed position may be sequentially controlled by appropriate control means. Also, the positioning of the plastics feed gate or gates, if more than one is provided, in the mould cavity, should be selected to optimise the flow of plastics into the mould cavity. As explained above, it may be necessary to prevent in mould gas pressure from forcing the plastics back into the injection moulding machine by using a shut-off valve 40, as illustrated, or by holding the ram screw forward, or by use of a hot runner system with valve gates.

A graph illustrating the sequence of steps described above is shown in FIG. 2. The graph is referred to generally by the reference numeral 60 in FIG. 2 and charts the moulding cycle time relative to the pressure in the mould. In this regard, the pressure in the mould initially increases as shown by line 62 as the plastics is injected into the mould cavity. The moulding machine then holds the plastics packed pressure as shown by line 64. The time at which the machine packs the pressure is indicated by the arrow 66. That time can be adjusted as desired.

Thereafter, as shown by line 68, the gas is injected into the plastics material in the mould cavity. At point 70, the valve member 44 regulating the flow of plastics material into the secondary cavity is opened. This allows plastics to be expelled from the mould cavity into the secondary cavity. This step is indicated by the arrow 72. Thereafter, the pressure of the gas in the mould cavity is held. This is shown by line 74. The time of the gas packing pressure is shown by the arrow 76 in FIG. 2.

Subsequently, the gas pressure is reduced in the mould. This is shown by line 78. The gas pressure can also be held constant for a period of time, as shown at 80, in order to allow the plastics material to cool and harden. Thereafter, that is once the plastics part is cooled and hardened, the gas is ejected from the mould. Once the pressure of the gas is vented or exhausted from the mould cavity, as shown by line 82, the mould is opened and the part removed. This is shown at point 84 on the graph of FIG. 2.

With the system and process of the present invention, the method is not dependent on the injection of an accurately controlled shot volume of plastics repeatedly shot after shot. Also, the ability to pressure pack the plastics, due to volumetric contraction or shrinkage of the plastics, while the mould cavity is filled with plastics, or is filled with plastics and initial injection of gas, ensures accurate replication of the mould cavity surface without shrinkage of the plastics from the surface.

Avoiding the need to partially fill the article cavity eliminates the tendency to form hesitation marks on the product at positions to which the plastics flows and stops before the gas is injected.

The dependence on a fixed volume of plastics material which is expelled from the mould cavity eliminates the variable dependence on timing of the gas injection. Also, the present invention is suitable for multi-cavity moulds, with each cavity being able to be connected to one or more secondary cavities, thereby eliminating any need to balance the flow of plastics in order to partially fill each mould cavity.

The present invention is suitable for a wide range of thermoplastics resin materials, including glass-filled fibre materials which require early pressurisation in order to achieve acceptable surface finishes. Also, a more consistent and uniform wall section thickness is achievable throughout the length of the gas channel as a result of more positive control of the gas and plastic flows. The process is further operable on moulding machines which are not capable of accurately delivering consistent volumes of plastics material.

The position of the or each gas injector in the mould cavity is not as critical as it is with other processes in which overflow cavities are utilised. In this regard, the present invention is suitable for expelling plastics from more than one position in a mould cavity. Also, the valve members in to the secondary cavities can be sequentially opened and closed in order to optimise plastic expulsion and to avoid thick accumulations of plastics remaining in the moulded article.

With the present invention, the injection of an unpressurised accurate shot weight or filling volume is not necessary. Also, the timing of the gas injection is not as critical as in other processes. The packed pressure exerted by the moulding machine and subsequently the gas when the cavity is full of plastics material ensures a good reproducibility of the mould cavity and the moulded article itself. Flow and weld marks are reduced. Also, the appearance of hesitation marks, when partial filling of a cavity is desired, is also infrequent or minimised with the present invention.

The operation of the valve member 42, as well as any other valve members which are positioned between the mould cavity and respective secondary cavities, can be operated independently and timed to be sequential with the other secondary cavities. This allows the plastics to be expelled from the mould cavity in a desired sequence and in order to allow formation of various channels in various thicker sections or members of the moulded article. Also, as noted, the volume of plastics expelled from the mould cavity is not dependent on the timing of the gas injection. Instead, it is dependent on the timing of the valves and the volume of the secondary cavity or cavities and the opening and closing sequence of the valve members from the mould cavity into the secondary cavities.

In a further embodiment of the present invention, the valves in the flow runners or conduits between the mould cavity and the secondary cavity or cavities can be operated in a different manner. The valve members may be operable by the application of a selected pressure which is exerted by the injection of gas and in turn a transmission of pressure to the plastics material. This in turn will open the valve member, thus overcoming a preset closing force. The present closing forces may be applied to the valve members by mechanical spring members or other means, such as pneumatic, hydraulic, or electric.

Further, the opening and closing of the valve members may be controlled by any conventional means, such as pneumatic, hydraulic, electrical, or mechanical means. The opening and closing of the valve members can also be controlled by external means which may include digital or computer timing, external or integral with the gas pressure control means.

FIGS. 3A-3E illustrate the same apparatus as in the embodiment of FIGS. 1A-1E, but an alternative sequence of steps of a process for injection moulding a hollow plastics article.

In this embodiment, the quantity of molten plastics material 20 in the barrel 22 of the injection moulding machine is at least sufficient to fill or substantially fill the volume of the mould cavity 30 without packing the plastics material in the mould cavity.

Referring to FIG. 3, the second step in the process is shown in FIG. 3B. In this step, the molten plastics resin material 20 is injected by the injection moulding machine into the mould cavity 30, with valve member 40 open and valve member 42 closed, but the step of injecting the plastics material is completed before packing of the plastics material in the mould cavity occurs.

Following injection of the plastics material, with the valve member 40 still closed, pressurised gas, e.g. nitrogen, is injected at selected ram and hold pressures through inlet conduit 50. This is possible due to volumetric contraction or shrinkage of the plastics material and is shown in FIG. 3C. Initially, the valve member 42 remains in a closed condition for a predetermined amount of time such that the pressure of the gas creates a hollow cavity in the molten material 20 and applies a packing pressure which forces the plastics material against the inner surfaces of the mould cavity 30, and an outer skin of the plastics material has solidified whilst a core portion of the plastics material remains molten, thereby helping to provide a good surface finish on the plastics product.

Thereafter, as shown in FIG. 3D, the valve member 42 is opened. The pressure of the gas 52 in the molten plastics material 20 in the mould cavity 30 causes a portion of the molten plastics to be expelled from the mould cavity into the secondary cavity 32. As before, the molten plastics material is preferably expelled from the centre of the thicker section or sections in the moulded article through the connecting conduit or runner 44. Thereafter, a gas “hold” or “packing” pressure is maintained in the mould cavity while the plastics material cools and solidifies.

Once the remaining plastics material in the mould cavity has sufficiently cooled and solidified, the gas 52 is exhausted. This is shown in FIG. 3E. Thereafter, the mould is opened and the finished plastics article is ejected or removed from the mould cavity. At the same time, the expelled plastics material 21 in the or each secondary cavity 32 is similarly ejected or removed from the mould.

A graph illustrating the sequence of steps described above is shown in FIG. 4. The graph is referred to generally by the reference numeral 60 in FIG. 4, and charts the moulding cycle time relative to the pressure in the mould. The pressure in the mould initially increases as shown by line 62 as the plastics is injected into the mould cavity, without the moulding machine holding the plastics pressure to pack the plastics.

Thereafter, as shown in line 68, the gas is injected into the plastics material in the mould cavity and applies a packing pressure to the plastics material as shown byline 73. At point 70, the valve member 44 regulating the flow of plastics material into the secondary cavity is opened. This allows plastics to be expelled from the mould cavity into the secondary cavity. This step is indicated by the arrow 72. Thereafter, the pressure of the gas in the mould cavity is held. This is shown by line 74. The time of the gas packing pressure is shown by the arrow 76 in FIG. 4.

Subsequently, the gas pressure is reduced in the mould. This is shown by line 78. The gas pressure can also be held constant for a period of time, as shown at 80, in order to allow the plastics material to cool and harden. Thereafter, that is once the plastics article is cooled and hardened, the gas is ejected from the mould. Once the pressure of the gas is vented or exhausted from the mould cavity, as shown by line 82, the mould is opened and the moulded article removed. This is shown at point 84 on the graph of FIG. 4.

The ability to pressure pack the plastics during initial injection of gas, assists replication of the mould cavity surface without shrinkage of the plastics from the surface.

Also, avoiding the need to partially fill the mould cavity eliminates the tendency to form hesitation marks on the article at positions to which the plastics flows and stops before the gas is injected.

Alternatively or additionally to expelling a portion of the plastics material into one or more secondary cavities, it is also possible to expel a portion of the plastics material back into the injection moulding machine barrel, the barrel thereby constituting a secondary cavity. This is accomplished by the gas pressure pushing back the injection screw or piston against a controllable back pressure. This process is shown in FIGS. 5A-5E and referred to generally by the reference numeral 100. As shown in FIG. 5A, plastics material 102 is positioned in a barrel 104 of an injection moulding machine 101. The barrel 104 has a nozzle 106 which is connected in any conventional manner with a mould cavity 108. A valve member 110 controls the flow of plastics from the barrel member into the mould cavity. At the initial sequence of steps, as shown in FIG. 5B, the valve member 110 is opened allowing plastics material to be injected from the barrel 104 into the mould cavity 108. Thereafter, the pressure is temporarily held by the injection moulding machine relative to the plastics in the mould cavity 108, preferably for at least 1-5 seconds.

With the machine screw or plunger 130 held forward or valve 110 closed, gas injection begins through gas injection conduit 120, the gas creating a hollow cavity in the plastics material and forcing the plastics material against the inner surfaces of the mould cavity. An outer skin of the plastics material becomes solidified whilst a core portion of the plastics material remains molten.

Thereafter, as shown in FIG. 5C, gas continues to be injected into the plastics material in the mould cavity through gas injection conduit 120, with the valve member 110 open. The gas 122 expels a portion of the plastics back into the machine cylinder or barrel 104 and extends the hollow cavity in the plastics material in the mould cavity 1.0.8.

At this point in the process, the pressure is reduced from the moulding machine screw or plunger member 130 which enables expulsion of molten plastics material 102 from the mould cavity back into the machine cylinder or barrel 104. Space in the barrel 104 can be formed by the pressure of the gas forcing the plunger member 130 away from the mould.

Following completion of plastics expulsion, the gas pressure is held during cooling and solidification of the remaining plastics material in the mould cavity, and valve member 110 is closed. This is shown in FIG. 5D. At this point, the plastics is subjected to packing pressure and has its surface forced tightly against the inside surfaces of the mould cavity. This produces a good surface finish and creates a full definition of the surface of the mould. Thereafter, the gas pressure in the mould cavity is reduced under control to atmospheric pressure. This is shown in FIG. 5E. Thereafter, the machine barrel 104 is completely refilled with plastics material, ready for the next moulding cycle. At the same time, the mould is opened and the formed plastics part is removed or ejected from the moulding machine.

The advantages of this alternative embodiment of the present invention is that the expelled plastics can be remoulded in succeeding shots. This eliminates regrinding or recovery of the expelled material from a spillover or secondary cavity. Also, retrimming of the moulding is not necessary, and the system does not have to expend the cost of additional shutoff valves in the runner members.

An alternative process is shown in FIGS. 6A-6E and referred to generally by the reference numeral 100. As shown in FIG. 6A, a quantity of molten plastics material 102 is positioned in barrel 104 of injection moulding machine 101, and the apparatus is the same as the apparatus illustrated in FIG. 5A. At the initial sequence of steps of this alternative process, as shown in FIG. 6B, the valve member 110 is opened allowing molten plastics material to be injected from the barrel 104 into the mould cavity 108 without packing the plastics.

Thereafter the gas injection step is commenced. This is achieved either with the piston 130 of the moulding machine held forward and the valve member 110 open, or with the valve member 110 closed as shown in FIG. 6C. In either case, gas is injected through conduit 120 and begins to create a hollow cavity in the plastics material in the mould cavity 108 thereby packing the plastics in the mould cavity.

After a predetermined time delay, whilst continuing to maintain gas pressure, the pressure is reduced from the moulding machine screw or piston 131 and/or the valve member 110 is opened, which enables the gas to progressively expel molten plastics material from the mould cavity 108 back into the machine cylinder or barrel 104 (FIG. 6D), the gas forcing the piston 130 away from the mould.

The step of expelling a portion of the plastics material back into the barrel 104 is controlled so that a predetermined amount of plastics is expelled in a controlled manner. Controlling the flow of plastics may be achieved by maintaining a back pressure on the piston 130 whilst controlling the speed at which the pressure of the plastics retracts the piston and/or controlling the final position of the piston. Alternatively, the amount of plastics which is expelled may be controlled first by controlling the speed at which the pressure of plastics retracts the piston whilst maintaining a back pressure on the piston, and subsequently closing the nozzle valve 110. In each case, the flow of gas does not extend beyond the nozzle valve 110, to avoid fouling of the plastics in the barrel which is injected into the mould cavity 108 during the succeeding moulding cycle.

Following completion of plastics expulsion, the gas pressure is held during cooling and solidification of the remaining plastics material in the mould cavity. At this point, the plastics is subjected to packing pressure by the gas and has its surface forced tightly against the inner wall surfaces of the mould cavity. This produces a good surface finish and creates a full definition of the surface of the mould. Thereafter, the gas pressure in the mould cavity is reduced under control to atmospheric pressure. This is shown in FIG. 6E. Thereafter, the machine barrel 104 is completely refilled with plastics material ready for the next moulding cycle. At the same time, the mould is opened and the moulded plastics article is removed or ejected from the mould.

As described above, the expelled plastics can be remoulded in succeeding shots. Also, retrimming of the moulding is not necessary, and the system does not have to expend the cost of additional shut-off valves in the runner members to separate secondary cavities.

An embodiment of the invention in which more than one secondary cavity is utilised is shown in FIGS. 7A-7F and designated generally by the reference numeral 150. The embodiment 150 includes an injection moulding machine 152 which is set up to inject a quantity of molten plastics material 154 into a mould cavity 156 in a mould. The primary mould cavity 156 has a pair of secondary cavities 158 and 160 which are connected to the mould cavity 156 by conduits or runners 162 and 164 respectively. Valve members 166 and 168 are positioned in the conduits and act to open and close the flow plastics from the mould cavity 156, to the secondary cavities. Another valve member 170 is positioned at the inlet to the primary mould cavity 156 (or in the nozzle) and used to open and close the conduit 172 which connects the injection moulding machine nozzle to the mould cavity. Port or pin member 174 is used to inject gas into the mould cavity.

The sequence of steps for use of system 150 is illustrated in FIGS. 7A-7F. Molten plastics material 154A is first injected into the mould cavity and retained there for a brief period of “packing pressure” (FIG. 7B). Gas 180 is then injected into the plastics material in the mould cavity and the pressure is held for an amount of time which ensures that the plastics material is held against the inner-wall surfaces of the mould cavity and an outer skin of the plastics material has solidified whilst a core portion of the plastics material remains molten (FIG. 7C). Valve member 166 is then opened and a first quantity of plastics material 154B is expelled into a first secondary cavity 158 (FIG. 7D). Thereafter, valve member 168 is opened and a second quantity of plastics material 154C is expelled into a second secondary cavity 160 (FIG. 7E). Once the part has cooled and solidified sufficiently, the gas is exhausted back through port 174 (FIG. 7F). In the final steps, the mould is opened, the part is ejected, and the system is prepared for the start of another cycle.

An alternative embodiment in which more than one secondary cavity is utilised is shown in FIGS. 8A-8F and designated generally by the reference numeral 150. As shown in FIG. 8A, an injection moulding machine 152 is set up to inject a quantity of molten plastics material 154 into a mould cavity 156 in a mould.

The sequence of steps in this alternative embodiment is illustrated in FIGS. 8A-8F. Molten plastics material 154A is first injected into the mould cavity (FIG. 8B) without packing of the plastics. Gas 180 is then injected into the plastics material in the mould cavity and the pressure is held for an amount of time which ensures that the plastics material is held against the inner wall surfaces of the mould cavity and an outer skin of the plastics material has solidified whilst a core portion of the plastics material remains molten (FIG. 8C). Valve member 166 is then opened and a first quantity of plastics material 154B is expelled into a first secondary cavity-158 (FIG. 8D). Thereafter, valve member 168 is opened and a second quantity of plastics material 154C is expelled into a second secondary cavity 160 (FIG. 8E). Once the part has cooled and solidified sufficiently, the gas is exhausted back through port 174 (FIG. 4F). In the final steps, the mould is opened, the part is ejected, and the system is prepared for the start of another cycle.

The embodiments shown in FIGS. 7A-7F and FIGS. 8A-8F are representative of embodiments in accordance with the present invention in which more than one secondary cavity is utilised. Variations and changes can be made by persons of ordinary skill in the art to develop other multiple secondary cavity systems. It is often advantageous to expel portions of the plastics material into second, third, or even fourth secondary cavities in order to relieve thick sections of the plastics remaining after the first expulsion. This can be evident in a non-uniformly thick section moulding such as an automobile door handle.

The operation of the valve member 42, as well as any other valve members which are positioned between the mould cavity and the secondary cavities, can be operated independently and timed to be sequential with the other secondary cavities. This allows the plastics to be expelled from the mould cavity in a desired sequence and in order to allow formation of various channels in various thicker sections or members of the product. Also, as noted above, the volume of plastics expelled from the mould cavity is not dependent on the timing of the gas. Instead, it is dependent on the timing of the valves and the volume of the secondary cavity or cavities, and the opening and closing sequence of the valve members from the mould cavity into the secondary cavities.

In a further embodiment of the present invention, the valves in the runners or conduits between the mould cavity and the secondary cavity or cavities can be operated in a different manner. The valve members may be operable by the application of a selected pressure which is exerted by the injection of gas and in turn a transmission of pressure to the plastics material. This in turn will open the valve member, thus overcoming a preset closing force. The preset closing forces may be applied to the valve members by mechanical spring members or other means, such as pneumatic, hydraulic, or electric.

Further, the opening and closing of the valve members may be controlled by any conventional means, such as pneumatic, hydraulic, electrical, or mechanical means. The opening and closing of the valve members can also be controlled by external means which may include digital or computer timing, external or integral with the gas pressure control means.

The present invention also can be used in the manufacture of hollow tubular components. A preferred moulding system and process for this is shown in FIGS. 9A-9F, while other embodiments of portions of this mechanism and system are illustrated in FIGS. 11 and 12. There is a need today for the manufacture of hollow tubular components from plastics materials. These components can be used, for example, as rollers for printers. The tubular components have to be dimensionally stable and straight circular cross-sections with concentric hollow intersections in many cases. It is also desirable to include features in the moulding which could normally not be extruded, but which are possible with injection moulded products. These include grooving or screw threads on the outer surface, brackets and other external fittings, connection mechanisms for use as spindles, and the inclusion of gear teeth or other configurations to provide ways to rotate the roller.

With conventional injection moulding techniques, either as a solid section or with mechanically moving side cores to form the inter-tubular section, it is difficult to achieve flatness without distortion over the length of the component and to reduce moulding time cycles. In prior attempts to use gas assisted moulding for hollow products or components, it has proved difficult to achieve concentricity and uniform wall section thickness along the length of the tubular components.

In order to achieve axial flatness over the length of the tubular section, uniform shrinkage of the plastics as it cools and changes from a liquid into a solid should be achieved. It is also important to eliminate or minimise stress in the moulding of the plastics since moulding stresses can cause ejected parts to distort or warp. Injection moulded plastics parts which have stress in them have a tendency to relieve that stress by distortion and warpage of the component after they are ejected from the mould.

With the present invention, concentricity and uniformity of wall section can be achieved. The plastics and gas flows are controlled in an axial direction, and there is no random or uncontrolled sideways movement or turbulence in the plastics, flow. The gas flows axially at the centre of the tubular section and is utilised to expel the plastics uniformly throughout the length of the tube into the secondary cavity or cavities. There is no lateral movement of the plastics after forming and within the semi-molten skin adjacent to the mould cavity surface. A uniform rate of cooling is achieved since there is good temperature control of the mould cavity members and there is a good plastics to mould surface contact to ensure uniform conduction of heat from the plastics.

In order to achieve a flow of plastics without turbulence, a mould cavity is formed which has a circular middle section and two cone-shaped configurations at the two ends. The molten plastics is injected through a peripheral film gate from a runner surrounding the gate section feeding into the apex of the cone at the inlet end. The plastics is injected along a thinner section and it flows and expands gradually along a cone or cone-like configuration up to the maximum required cylindrical section. Thereby the plastics maintains contact with the surfaces of the mould cavity as the mould cavity is filled.

The gas is injected in a central position along the axis of the tube and used to expel the plastics from the centre. The gas is injected near the apex of the cone in order to allow a gradual expansion into the desired intersection of the plastics. The speed of plastics injection is controlled from an initially slow rate and increased to a faster rate after the cone is filled and as the plastics completes the filling of the cylindrical section. The speed of the plastics injection slows again before the final cavity filling is completed.

The control of the gas injection speed, and therefore the pressure, is also controlled such that the gas is injected at a low pressure before expulsion of the plastics begins. This means that the pressure in which the gas is injected is lower before the opening of the valve in the runner or conduit which connects the mould cavity to the secondary cavity.

The tubular section at the distal end of the mould cavity adjacent to the secondary cavity can be reduced in size to gradually reduce the flow of plastics to a thinner section. Thi's allows the expulsion of the plastics to be controlled through the outflow runner and stop valve into the secondary cavity. In this regard, a second cone-shaped cavity configuration is shown in the drawings and described below, but it is to be understood that any shape or configuration can be utilised at the distal end of the mould cavity. However, it is preferred that the cross-sectional size be reduced at the distal end of the cavity.

A sequence of steps which can be utilised in the plastics expulsion process in order to manufacture hollow tubular components is shown in FIGS. 9A-9F. The process is generally referred to by the reference numeral 200 in the drawings.

As shown in FIG. 9A, the mould cavity 202 generally has a central elongated portion or section 204, a cone shaped configuration 206 at the leading end (that is the entrance at which the gas and plastics are injected into the cavity), and preferably a corresponding cone-shaped configuration 208 at the distal end adjacent a secondary cavity 210. A valve member 212 is positioned in the conduit or runner connecting the mould cavity 202 with the secondary cavity 210. The valve member can be any conventional type, such as those described above with reference to FIGS. 1 to 8. The valve member may also have a tapered leading edge, as illustrated in FIGS. 9A-9F.

Plastics introduced into the mould cavity 202 through runner 220 and film gate 222. Detailed versions of the plastics feed runner 220 and the plastics gate 222 are better shown in FIGS. 11 and 12.

The gas is injected into the mould cavity from gas injector port 230 which is positioned at the apex of the cone-shaped inlet section 206. Gas is directed to the port 230 from conduit or inlet line 232.

Also, as shown in FIGS. 11 and 12, it is possible to have a moving core 240 as part of the mechanism and system.

As shown in FIG. 9B, the sequence of the moulding process includes the initial injection of molten plastics material into the mould cavity 202. At this point, the valve member 212 is closed. After the plastics is injected into the mould cavity, the plastics is pressurised or packed in the cavity in order to provide good surface characteristics of the outer surface of the moulded component. In this regard, the plastics is pressurised and compacted for a short dwell period of time of the order of 1-5 seconds by the moulding machine. This ensures good reproducibility of the mould surface on the moulded product or article and good replications of the mould cavity shape.

Thereafter, as shown in FIG. 9C, the injection of the gas is commenced. The gas, which is shown schematically by the reference numeral 250, creates a cavity in the plastics material, and continues to apply pressure within the plastics in the mould-cavity 202. After a short dwell time in which the gas pressure is utilised to assist in forcing the plastics material against the internal walls or surfaces of the mould cavity and to ensure that an outer skin of the plastics material has solidified whilst a core portion of the plastics material remains molten, the valve member 212 is opened.

With the valve member 212 opened (FIG. 9D), the Molten plastics material in the centre of the mould 20′ cavity 202 is allowed to be expelled from the mould cavity. The expulsion of the molten plastics is taken from the centre of the tubular section and enters the secondary cavity 210 through the connecting runner 214. In FIG. 9D, the hollow centre of the tubular component, which is filled with gas, is indicated by the reference numeral 250, while the outer plastics now tubular component is referred to by the reference numeral 252. The plastics material in the secondary or overflow cavity 210 is referred to by the reference numeral 252A.

When the expulsion of plastics is complete, the gas pressure within the inner tubular channel is maintained so that the outer surface of the plastics remains in contact uniformly with the mould cavity surface, thereby ensuring uniform conduction of heat from the plastics to the mould.

After complete solidification of the plastics tubular component, the gas pressure is relieved and the gas is exhausted from the mould. This is shown in FIG. 9E. Thereafter the movable core (if utilised) is removed from the mould cavity (FIG. 9F), and the mould is opened and the part ejected. The portion of the plastics material 252A in the secondary cavity 210 is also ejected at the same time. In this regard, as indicated above, the plastics material in the secondary cavity can be reground and used again, can be scrapped, or can be made into another plastics component or part having the shape of the secondary cavity.

Once the plastics tubular component is formed and ejected from the mould, post moulding operations are necessary in order to trim off the cone sections at each end. This forms the final hollow tube or component.

The cone-shaped sections or configurations 206 and 208 of the mould cavity 202 preferably have included angles up to between 10-60 degrees. This assists in the uniform axial fill of the plastics from the apex of the cone and allows the plastics to expand up to the maximum cylindrical section as required in order to avoid turbulence or non-uniform flow of the plastics material.

Injecting the gas at an axial direction from a gas injection assembly or port 230 mounted in a movable core assembly 240 enables the gas injector to be withdrawn axially from the moulded component before the mould is opened and the part is ejected.

An alternative process for moulding hollow tubular components is shown in FIGS. 10A-10F. The apparatus is the same as shown in FIG. 9A. As before, plastics is introduced into the mould cavity. 202 through runner 220, 222 and film gate-224, but without packing the plastics. At this point, the valve member 212 is closed (FIG. 10B).

Thereafter, as shown in FIG. 10C, the injection of the gas is commenced. The gas which is shown schematically by the reference numeral 250, creates a cavity in the plastics material and continues to apply pressure within the plastics in the mould cavity 202. After a short dwell time in which the gas pressure is utilised to assist in forcing the plastics material against the internal walls or surfaces of the mould cavity, and to ensure that an the outer skin of the plastics material has solidified whilst a core portion of the plastics material remains molten, the valve member 212 is opened.

With the valve member 212 opened (FIG. 10D)., the molten plastics material in the centre of the mould cavity 202 is allowed to be expelled from the mould cavity. The expulsion of the molten plastics is taken from the centre of the tubular section and enters the secondary cavity 210 through the connecting runner 214 acting as an overflow.

When the expulsion of plastics is complete, the gas pressure within the inner tubular channel is maintained so that the outer surface of the plastics remains in contact uniformly with the mould cavity surface, thereby ensuring uniform conduction of heat from the plastics to the mould.

After cooling and solidification of the plastics tubular component, the gas pressure is relieved and the gas is exhausted or vented from the mould cavity. This is shown in FIG. 10E. As before, the movable core (if utilised) is removed from the mould cavity (FIG. 10F), and the mould is opened and the moulded article ejected.

As an additional embodiment in the system and process of FIG. 9 or FIG. 10, the movable gas injector and plastics feed gate can be combined in order to feed the plastics to a ring gate configuration in which the plastics flows from a ringed runner 222 formed around the gas injector barrel, and then through a thinner ringed gate 224 flowing into the mould cavity so that it is coaxial with the gas injection when the gas is injected after the mould filling is complete. Thereby the plastics maintains contact with the surfaces of the mould cavity as the mould cavity is filled. This is illustrated in FIG. 12. An alternative configuration of the plastics runner can be utilised where the runner is formed by a groove between the enlarged movable core and the mould plate. This is illustrated in FIG. 11.

It is possible in accordance with this hollow tubular embodiment to use either version of the plastics expulsion process as described above with respect to FIGS. 5A-5E or FIGS. 6A-6E. In either alternative embodiment, the molten plastics is expelled back into the moulding machine cylinder, as well as or instead of into a secondary cavity. The expelled plastics forces back the screw in the barrel of the moulding machine to provide the necessary controlled space volume within the cylinder.

For these alternative embodiments, the gas is injected from a cone extension of the tubular component at the opposite end to the plastics feed gate section. The gas injector is mounted on a movable side core which injects the gas into the mould cavity in an axial direction, thereby expelling a uniform flow of plastics exiting from the cone-shaped feed section, through the feed gates, runners, and sprue and back into the machine cylinder. The gas pressure is maintained in the mould cavity in order to force the plastics against the surfaces of the mould cavity, which ensures good service replication and uniform conduction of heat from the plastics to the mould.

In the manufacture of an injection moulded tubular structure of component, the component can be moulded as one piece and can be moulded together with additional features, such as pulley wheels, gear wheels with profiled teeth, or with screw threads, grooves, or other profiles on the outer surface of the tubular section. These additional features can be formed by machining applicable cavities for them in the mould cavity surfaces.

In further embodiments, similar to each of the above, there is employed a pressurised liquid, instead of pressurised gas, to create a hollow cavity in the plastics material in the mould cavity as a result of volumetric contraction or shrinkage of the plastics material, and to apply a packing pressure. Again, the packing pressure first creates a hollow cavity in the plastics material and applies a packing pressure which forces the plastics material against the inner surfaces of the mould cavity. The packing pressure is also held for a period of time which ensures that an outer skin of the plastics material has solidified whilst a core portion of the plastics material remains molten. Subsequently the pressurised liquid expels a portion of the plastics material from the mould cavity into one or more secondary cavities and/or back into the injection machine barrel, the barrel constituting a secondary cavity. The liquid is conveniently water, but other liquids may be used, if desired. The, use of cold water can also reduce the time of the cooling stage and thereby shorten the cycle time.

FIGS. 13 and 14 are two graphs which correspond to FIGS. 2 and 4 respectively, for the use of liquid instead of gas as the pressurising fluid.

The graph of FIG. 13 includes the step of using the moulding machine to hold the plastics pressure to pack the plastics as shown by line 64. The time at which the machine packs the plastics is indicated by the arrow 66. That time can be adjusted as desired.

Thereafter, as shown by line 68, the pressurised liquid is injected into the plastics material in the mould cavity and applies a further packing pressure to the plastics material. The moulding cycle then continues as described above in connection with FIG. 2.

The ability to pressure pack the plastics both while the mould cavity is filled with plastics, and while the mould cavity is filled with plastics and during initial injection of pressurised liquid, assists to ensure accurate replication of the mould surface without shrinkage of the plastics from the surface.

The graph of FIG. 14 illustrates the alternative process in which the mould cavity is filled with plastics material without the step of packing the plastics material before the injection of the pressurised liquid into the plastics material. Thereafter, the moulding cycle continues as described above in connection with FIG. 4.

One advantage of employing a liquid rather than a gas as the pressurising fluid is to provide a smoother internal wall surface within the plastics material, which is particularly desirable in the case of the tubular products of the above embodiments of FIGS. 9 to 12. Another advantage is that gas can tend to permeate into the wall of plastics material. Permeation is avoided or reduced by the use of liquid as the pressuring fluid.

In a further embodiment, the secondary cavity or at least one secondary cavity is positioned in the mould, but upstream of the mould cavity, the secondary cavity being coupled to the flow runner or conduit through which the plastics is injected into the mould cavity.

Alternatively or additionally, the secondary cavity or at least one secondary cavity is coupled to the mould cavity at a position within the mould cavity, and near to the plastics feed position in the mould cavity.

In either case, the gas or liquid injection position can then be positioned in the mould cavity and downstream of both the plastics feed position and the or each secondary cavity so that the expulsion of plastics material from the mould cavity is in a substantially contra direction ti the flow of plastics material during the filling of the mould cavity.

1. A process for injection moulding a hollow plastics article comprising the steps of:
(a) injecting a quantity of molten plastics material into a mould cavity at least to substantially fill the mould cavity;
(b) injecting pressurised gas or pressurised liquid into the plastics material in the mould cavity;
(c) allowing a portion of the molten plastics material in the mould to be expelled into at least one secondary cavity coupled to the mould cavity;
(d) permitting the remaining plastics material in the mould cavity to solidify;
(e) exhausting the gas or liquid from the mould cavity; and
(f) removing the plastics article from the mould;
characterised by holding the pressure of the gas or liquid on the plastics material in the mould cavity for a period of time in order to apply a packing pressure to the plastics material before allowing a portion of the plastics material to be expelled into said at least one secondary cavity.

2. A process as claimed in claim 1, wherein the step of holding the pressure of the gas or liquid on the plastics material in the mould cavity ensures that the plastics material is held against a wall surface of the mould cavity and an outer skin of the plastics material has solidified whilst a core portion of the plastics material remains molten.

3. The process as claimed in claim 1 or claim 2, wherein the step of injecting plastics material into the mould cavity is effected without packing of the plastics material.

4. The process as claimed in claim 1 or claim 2, including the step of applying a packing pressure to the plastics material injection pressure in the mould cavity, prior to the injection of the pressurised gas or liquid into the plastics material in the mould cavity.

5. A process as claimed in claim 4, wherein an injection moulding machine is employed to inject the plastics material into the mould cavity and to apply an initial packing pressure to the plastics material, the pressurised gas or liquid applying a further packing pressure to the plastics material in the mould cavity.

6. The process as claimed in claim 4 or claim 5, comprising the step of applying the packing pressure to the plastics material injection pressure in the mould cavity for a predetermined amount of time prior to the injection of gas or liquid into the plastics material.

7. A process as claimed in any one of the preceding claims, wherein the expulsion step is achieved by opening a valve in a flow runner or conduit connecting the mould cavity to the or each secondary cavity whilst maintaining gas or liquid pressure in the mould cavity.

8. A process as claimed in any one of the preceding claims, wherein the plastics article to be: moulded has at least one section which is thicker than other sections and the charge of pressurised gas or liquid is introduced into the thicker section in order to form a hollow portion therein.

9. A process as claimed in any one of the preceding claims, including the step of adjusting the volume of said at least one secondary cavity in order to allow expulsion of a predetermined amount of plastics material from the mould cavity.

10. A process as claimed in any one of the preceding claims, wherein portions of the plastics material are expelled into at least two secondary cavities.

11. A process as claimed in any one of the preceding claims, wherein at least two secondary cavities are provided and the step of allowing portions of the plastics material in the mould to be expelled into the secondary cavities comprises opening valve members positioned in respective flow runners or conduits connecting the mould cavity with the secondary cavities.

12. A process as claimed in claim 11, further comprising the step of sequentially controlling the opening of the valve members in order to allow selective expelling of plastics material into the at least two secondary cavities.

13. A process as claimed in any one of the preceding claims, wherein the process is applied for injection moulding a hollow plastics tubular article, the mould cavity having a substantially cone-shaped inlet portion, an elongate central portion and an exit portion.

14. A process as claimed in claim 13, wherein said cone-shaped portion has an apex and said gas or liquid, is injected into the plastics material at said apex.

15. A process as claimed in claim 13 or claim 14, wherein said exit portion comprises a second substantially cone-shaped portion, said cone-shaped exit portion having an apex and said expulsion of plastics material from the mould cavity into the secondary cavity occurs through said apex.

16. A process as claimed in any one of claims 13 to 15, wherein the plastics material is injected into the mould cavity at said cone-shaped inlet portion and maintains contact with the surfaces of the mould cavity as the mould cavity is filled.

17. A process as claimed in claim 16, including a ring gate mechanism for injecting the plastics material into said cone-shaped inlet portion.

18. A process as claimed in any one of claims 13 to 17, including the step of trimming at least one end of the article to form a tubular article.

19. A process as claimed in claim 18, wherein the article is trimmed to form a tubular article of substantially constant cross-section.

20. A process as claimed in any one of the preceding claims, wherein said plastics material is injected into the mould cavity from an injection moulding machine with a barrel and nozzle, said process further comprising the step of allowing a portion of the plastics material in the mould to be expelled back into the barrel of the injection moulding machine, the barrel constituting the secondary cavity or one of the secondary cavities.

21. A process for injection moulding a hollow plastics article utilising an injection moulding machine with a barrel and nozzle and a mould with a mould cavity therein having a shape defining at least a portion of the article, said process comprising the steps of:
(a) injecting a quantity of molten plastics material into the mould cavity from the injection moulding machine at least to substantially fill the mould cavity;
(b) injecting pressurised gas or pressurised liquid into the plastics material in the mould cavity;
(c) allowing a portion of the molten plastics material in the mould to be expelled back into the barrel of the injection moulding machine;
(d) permitting the remaining plastics material in the mould cavity to solidify;
(e) exhausting the gas or liquid from the mould cavity; and
(f) removing the plastics article from the mould;
characterised by holding the pressure of the gas or liquid on the plastics material in the mould cavity for a period of time in order to apply a packing pressure to the plastics material before allowing said portion of the plastics material to be expelled back into the barrel of the injection moulding machine.

22. A process as claimed in claim 21, wherein the step of holding the pressure of the gas or liquid on the plastics material in the mould cavity ensures that the plastics material is held against a wall surface of the mould cavity and an outer skin of the plastics material has solidified whilst a core portion of the plastics material remains molten.

23. A process as claimed in claim 21 or claim 22, wherein the step of injecting plastics material into the mould cavity is effected without packing the plastics material.

24. A process as claimed in claim 21 or claim 22, wherein the injection moulding machine is employed to apply a packing pressure to the plastics material injection pressure in the mould cavity, prior to the injection of pressurised gas or liquid into the plastics material.

25. A process as claimed in claim 24, comprising the step of applying the packing pressure to the plastics material injection pressure in the mould cavity for a predetermined amount of time prior to the injection of gas or liquid into the plastics material.

26. A process as claimed in any one of claims 21 to 25, wherein the step of allowing plastics material to be expelled back into the barrel of the injection moulding machine is controlled so that a predetermined amount is expelled in a controlled manner.

27. A process as claimed in claim 26, wherein the amount of plastics material which is expelled is controlled by controlling the speed and/or the extent by which the plastics material retracts an injection piston or screw in the barrel of the injection moulding machine.

28. A process as claimed in claim 26 or claim 27, wherein the amount of plastics material which is expelled is controlled by timing the closure of a shut-off valve member positioned in the flow path between the moulding cavity and the barrel of the injection moulding machine.

29. A process as claimed in any one of claims 21 to 28, wherein the gas or liquid is injected into the plastics material at a location spaced from the nozzle of the injection moulding machine.

30. A process as claimed in any one of claims 21 to 29, wherein said plastics article has at least one section which is thicker than other sections and said pressurised gas or liquid is introduced into the thicker section in order to form a hollow portion therein.

31. A process as claimed in any one of claims 21 to 30, wherein the step of allowing a portion of the plastics material in the mould to be expelled back into the barrel of the injection moulding machine comprises opening a shut-off valve member positioned in the flow path between the mould cavity and the barrel of the injection moulding machine.

32. A process as claimed in claim 31, wherein the valve member is included as part of the nozzle of the injection moulding machine.

33. A process as claimed in any one of claims 21 to 32, wherein a first portion of the plastics material in the mould is allowed to be expelled back into the barrel of the injection moulding machine, and comprising the step of allowing a respective second portion of the plastics material in the mould to be expelled into one or more secondary cavities coupled to the mould cavity.

34. A process as claimed in claim 33, wherein the step of allowing one or more second portions of the plastics material to be expelled into a respective secondary cavity comprises opening a valve member positioned in the flow path between the mould cavity and the secondary cavity.

35. A process as claimed in any one of claims 1 to 20 or claim 33 or claim 34, comprising injecting the plastics material along a flow path into the mould cavity, and allowing one or more portions of the plastics material to be expelled into a secondary cavity or cavities coupled to the flow path.

36. A process as claimed in any one of claims 1 to 20 or claim 33 or claim 34, wherein the or each secondary cavity is coupled to the mould cavity at a position within the mould cavity and near to the plastics feed position in the mould cavity.

37. A process as claimed in claim 35 or claim 36, wherein the gas or liquid injection position is positioned in the mould cavity and downstream of the plastics feed position and the or each secondary cavity so that the expulsion of plastics material is in a substantially contra direction to the flow of plastics material during the filling of the mould cavity.

38. A process as claimed in any one of the preceding claims, wherein at least two gas or liquid injecting positions are provided in one mould cavity.

39. A process as claimed in claim 38, including the step of sequentially controlling the commencement of gas or liquid injection from each gas or liquid feed position in the mould cavity.

40. Apparatus for injection moulding a hollow plastics article comprising:
a mould with a mould cavity therein defining at least a portion of the article and at least one secondary cavity coupled to the mould cavity;
means for injecting a quantity of molten plastics material into the mould cavity at least to substantially fill the mould cavity; and
means for injecting pressurised gas or pressurised liquid into the plastics material in the mould cavity;
characterised in that control means are provided for holding the pressure of the gas or liquid on the plastics material in the mould cavity for a period of tine in order to apply a packing pressure to the plastics material before allowing a portion of the molten plastics material in the mould to be expelled into said at least one secondary cavity, prior to the remaining plastics material in the mould cavity solidifying and the gas or liquid being exhausted from the mould cavity to allow the removal of the plastics article from the mould.

41. Apparatus as claimed in claim 40, wherein the control means hold the pressure of the gas or liquid on the plastics material in the mould cavity for a period of time which ensures that the plastics material is held against a wall surface of the mould cavity and an outer skin of the plastics material has solidified whilst a core portion of the plastics material remains molten.

42. Apparatus as claimed in claim 40 or claim 41, wherein an injection moulding machine is employed to inject the plastics material into the mould cavity without packing the plastics material.

43. Apparatus as claimed in claim 40 or claim 41, wherein an injection moulding machine is employed to inject the plastics material into the mould cavity, and to apply a packing pressure to the plastics material injection pressure in the mould cavity, prior to the injection of the pressurised gas or liquid into the plastics material in the mould cavity.

44. Apparatus as claimed in claim 43, wherein the control means are adapted to apply the packing pressure to the plastics material injection pressure in the mould cavity for a predetermined amount of time prior to the injection of gas or liquid into the plastics material.

45. Apparatus as claimed in any one of claims 40 to 44, wherein the or each secondary cavity is connected to the mould cavity b a flow runner or conduit containing a valve controlled by said control means.

46. Apparatus as claimed in any one of claims 40 to 45, wherein the mould cavity is coupled to at least two secondary cavities by a respective flow runner or conduit, each coupling containing a controlled valve.

47. Apparatus as claimed in any one of claims 40 to 46, wherein the means for injecting plastics material into the mould cavity is an injection moulding machine with a barrel and nozzle, the nozzle being flow connected to the mould cavity and the barrel constituting a further secondary cavity.

48. Apparatus as claimed in claim 47, including a shut-off valve member positioned in the flow path between the mould cavity and the barrel of the injection moulding machine.

49. Apparatus as claimed in claim 48, wherein the valve member is included as part of the nozzle of the injection moulding machine.

50. Apparatus as claimed in any one of claims 40 to 49, for injection moulding a hollow plastics tubular article, the mould cavity having a substantially cone-shaped inlet portion, an elongated central portion and an exit portion.

51. Apparatus as claimed in claim 50, wherein said cone-shaped portion has an apex and said fluid is injected into the plastics material at said apex.

52. Apparatus as claimed in claim 50 or claim 51, wherein said exit portion comprises a second substantially cone-shaped portion, said cone-shaped exit portion having an apex and said expulsion of plastics material from the mould cavity into the secondary cavity occurs through said apex.

53. Apparatus as claimed in any one of claims 50 to 52, including a ring gate mechanism for injecting the plastics material into said cone-shaped inlet portion.

54. Apparatus as claimed in any one of claims 50 to 53, including means for trimming at least an end of the article to form a tubular article.

55. Apparatus as claimed in any one of claims 40 to 54, including a flow runner or conduit through which plastics is injected into the mould cavity, and one or more secondary cavities coupled to the flow runner or conduit.

56. Apparatus as claimed in any one of claims 40 to 54, wherein the or each secondary cavity is coupled to the mould cavity at a position within the mould cavity and hear to the plastics feed position in the mould cavity.

57. Apparatus as claimed in claim 55 or claim 56, wherein the gas or liquid position is positioned in the mould cavity and downstream of the plastics feed position and the or each secondary cavity so that the expulsion of plastics material is in a substantially contra direction to the flow of plastics material during the filling of the mould cavity.

58. Apparatus as claimed in any one of claims 40 to 57, wherein at least two gas or liquid injectors are provided in one mould cavity.

59. Apparatus as claimed in claim 58, including control means for sequentially controlling the commencement of gas or liquid injection from each injector.

60. Apparatus for injection moulding a hollow plastics article comprising:
an injection moulding machine with a barrel and a nozzle;
a mould with a mould cavity therein defining at least a portion of the article, for connection to the nozzle for injecting a quantity of molten plastics material into the mould cavity from the injection moulding machine; and
means for injecting pressurised gas or pressurised liquid into the plastics material in the mould cavity;
characterised in that control means are provided for holding the pressure of the gas or liquid on the plastics material in the mould cavity for a period of time in order to apply a packing pressure to the plastics material before allowing a portion of the molten plastics material in the mould to be expelled back into the barrel of the injection moulding machine, prior to the remaining plastics material in the mould cavity solidifying and the gas or liquid being exhausted from the mould cavity to allow the removal of the plastics article from the mould.

61. Apparatus as claimed in claim 60, wherein the control means hold the pressure of the gas or liquid on the plastics material in the mould cavity for a period of time which ensures that the plastics material is held against a wall surface of the mould cavity and an outer skin of the plastics material has solidified whilst a core portion of the plastics material remains molten.

62. Apparatus as claimed in claim 60 or claim 61, wherein the injection moulding machine is employed to inject the plastics material into the mould cavity without packing the plastics material.

63. Apparatus as claimed in claim 60 or claim 61, wherein the injection moulding machine applies a packing pressure to the plastics material injection pressure in the mould cavity, prior to the injection of the pressurised gas or liquid into the plastics material in the mould cavity.

64. Apparatus as claimed in claim 63, wherein the control means is adapted to apply the packing pressure to the plastics material injection pressure in the mould cavity for a predetermined amount of time prior to the injection of gas or liquid into the plastics material.

65. Apparatus as claimed in any one of claims 60 to 64, including a shut-off valve member positioned in the flow path between the mould cavity and the barrel of the injection moulding machine.

66. Apparatus as claimed in claim 65, wherein the valve member is included as part of the nozzle of the injection moulding machine.

67. A process as claimed in claim 7, wherein the valve is opened by the application of a selected pressure which is exerted by the injection of gas and in turn a transmission of pressure to the plastics material.

68. A process as claimed in claim 11 or claim 12, wherein each valve member is opened by the application of a selected pressure which is exerted by the injection of gas and in turn a transmission of pressure to the plastics material.
